(19) United States
(12) Patent Application Publication
(10) Pub. No.: US 2025/0060295 A1
(43) Pub. Date: Feb. 20, 2025

(54) VIBRONIC MULTISENSOR

(71) Applicant: Endress+Hauser SE+Co. KG, Maulburg (DE)

(72) Inventors: Romuald Girardey, Blotzheim (FR); Sergey Lopatin, Lörrach (DE); Jan Schleiferböck, Rümmingen (DE)

(21) Appl. No.: 18/687,874

(22) PCT Filed: Jul. 22, 2022
(86) PCT No.: PCT/EP2022/070632

§ 371 Date: Feb. 29, 2024

(30) Foreign Application Priority Data
Aug. 31, 2021 (DE) 10 2021 122 534.5

(51) Int. Cl. G01N 9/00; G01F 1/66; G01F 23/296; G01N 11/16

(52) U.S. Cl. CPC G01N 9/002; G01F 1/66; G01F 23/2967; G01N 11/16; G01N 2009/006

(57) ABSTRACT

A method for determining and/or monitoring first and second process variables of a medium in a containment, wherein a sensor unit is excited by means of an excitation signal such that mechanical oscillations are executed, the mechanical oscillations are received by the sensor unit and converted into a first received signal, a transmitted signal is transmitted from the sensor unit and a second received signal is received, and a first process variable is ascertained based on the first received signal and a second process variable is ascertained based on the second received signal. The transmitted signal is selected in such a manner that a standing wave is produced at least in a part of the medium between a first component of the sensor unit and a second component of the sensor unit or a wall of the containment.

The invention relates to a method for determining and/or monitoring at least a first process variable of a medium in a containment. The containment is, for example, a container or a pipeline. Suited for performing the method is a vibronic sensor for determining and/or monitoring at least one process variable with at least one sensor unit comprising a mechanically oscillatable unit.

Vibronic sensors are widely used in process and/or automation technology. In the case of fill level measuring devices, such have at least one mechanically oscillatable unit, such as, for example, an oscillatory fork, a single tine or a diaphragm. Such is excited during operation by means of an exciting/receiving unit, frequently in the form of an electromechanical transducer unit, such that mechanical oscillations are executed. The electromechanical transducer unit can be, for example, a piezoelectric drive or an electromagnetic drive. Corresponding field devices are manufactured by the applicant in great variety and sold, for example, under the LIQUIPHANT and SOLIPHANT marks. The underpinning measuring principles are known, in principle, from a large number of publications. The exciting/receiving unit excites the mechanically oscillatable unit by means of an electrical excitation signal, such that mechanical oscillations are executed. Conversely, the exciting/receiving unit can receive the mechanical oscillations of the mechanically oscillatable unit and convert such into an electrical, received signal. The exciting/receiving unit is either separate exciting and receiving units, or one combined exciting/receiving unit.

In such case, the exciting/receiving unit is in many cases part of a fed back, electrical, oscillatory circuit, by means of which the exciting of the mechanically oscillatable unit occurs, such that mechanical oscillations are executed. For example, for a resonant oscillation, the oscillatory circuit state must be created, in which the amplification factor is >1 and all phases arising in the oscillatory circuit sum to a multiple of 360°. For exciting and fulfilling the oscillatory circuit state, a certain phase shift between the excitation signal and the received signal needs to be assured. Therefore, frequently a predeterminable value for the phase shift, thus, a desired value for the phase shift between the excitation signal and the received signal, is set. For this, the state of the art offers the most varied of solutions, including both analog as well as also digital methods, such as described, for example, in DE102006034105A1, DE102007013557A1, DE102005015547A1, DE102009026685A1, DE102009028022A1, DE102010030982A1 and DE00102010030982A1.

Both the excitation signal as well as also the received signal are characterized by a frequency ω, an amplitude A and/or a phase @. Correspondingly, changes in these variables are usually taken into consideration for determining the particular process variable. The process variable can be, for example, a fill level, a predetermined fill level, or the density or viscosity of the medium, as well as flow, e.g. flow rate. In the case of a vibronic limit level switch for liquids, for example, it is distinguished, whether the oscillatable unit is covered by the liquid or freely oscillating. These two states, the free state and the covered state, are distinguished, in such case, for example, based on different resonance- or eigen frequencies, thus, based on frequencies in the case of a predetermined phase shift between excitation signal and received signal.

Density and/or viscosity can, in turn, only be ascertained with such a measuring device, when the oscillatable unit is completely covered by the medium. For determining density and/or viscosity, likewise different options are provided by the state of the art, such as those described, for example, in DE10050299A1, DE102007043811A1, DE10057974A1, DE102006033819A1, DE102015102834A1 and DE102016112743A1.

Known from DE102012100728A1 and DE102017130527A1 are various vibronic sensors, in the case of which the piezoelectric elements are arranged, at least partially, within the oscillatable unit. With such and similar arrangements, advantageously a plurality of process variables can be determined with a single sensor and used for characterizing different processes, such as described, for example, in WO2020/094266A1, DE102019116150A1, DE102019116151A1, DE02019116152A1, DE102019110821A1, DE102020105214A1 and DE102020116278A1.

In order to determine at least two different process variables by means of such a multisensor, the sensor unit is, on the one hand, excited by means of an excitation signal, such that mechanical oscillations are executed, and the mechanical oscillations of the sensor unit are received and converted into a first received signal. Additionally, a transmitted signal is transmitted from the sensor unit and a second received signal received. Based on the first received signal, then a first process variable can be ascertained, and, based on the second received signal, a second process variable can be ascertained. The sensor unit is part of an apparatus for determining and/or monitoring at least two different process variables of a medium and includes a mechanically oscillatable unit as well as at least one piezoelectric element. The mechanically oscillatable unit is, for example, a diaphragm, a single tine, an arrangement of at least two oscillatory elements, or an oscillatory fork. In the case of two piezoelectric elements, they can, moreover, serve, at least partially, as exciting/receiving unit for producing the mechanical oscillations of the mechanically oscillatable unit.

The accuracy of measurement and measuring performance of such multisensors depends on many different, for example, geometric, factors. On the one hand, stable mechanical oscillations of the oscillatable unit must be assured. Additionally, requirements with respect to a travel path for the transmitted signal must be taken into consideration.

An object of the invention is to improve the accuracy of measurement of such multisensors further.

The object is achieved by a method for determining and/or monitoring at least first and second process variables of a medium in a containment, wherein
a sensor unit is excited by means of an excitation signal, such that mechanical oscillations are executed,
the mechanical oscillations are received by the sensor unit and converted into a first received signal,
a transmitted signal is transmitted from the sensor unit and a second received signal is received, and
a first process variable is ascertained based on the first received signal and a second process variable is ascertained based on the second received signal.

According to the invention, the transmitted signal is selected in such a manner that a standing wave is produced at least in a part of the medium between a first component of the sensor unit and a second component of the sensor unit or a wall of the containment.

The mechanically oscillatable unit is, for example, a diaphragm, a single tine, or an arrangement having at least two oscillatory elements, especially an oscillatory fork. By means of the excitation signal, mechanical oscillations of the oscillatable unit are produced. When the oscillatable unit is covered by medium, the mechanical oscillations are influenced by the properties of the medium. Correspondingly, based on the first received signal, which represents oscillations of the oscillatable unit, information concerning the first process variable can be ascertained. The first process variable is correspondingly ascertained based on the vibronic measuring principle.

Also the transmitted signal passes, at least at times and sectionally, through the medium and is influenced by the physical and/or chemical properties of the medium and can correspondingly be taken into consideration for determining the second process variable of the medium. In order to determine the second process variable, the ultrasonic measuring principle is taken into consideration. Since a standing wave is produced between a first component of the sensor unit, for example, a piezoelectric element, and a second component of the sensor unit or a wall of the containment, the second process variable, especially a velocity of sound in the medium, can be ascertained indirectly based on a resonance of the medium. In this way, the accuracy of measurement can with simple means be increased. Additionally, significantly more compact sensors can be implemented. In the case of an evaluation of the second received signal as regards the travel time, in contrast, the achievable accuracy of measurement depends sensitively on the traveled distance. In the case of small travel distances, this means considerable inaccuracies or increased complexity as regards the detection means used for implementing a corresponding apparatus, and increased energy requirement of a corresponding measuring device.

In the context of the invention, it is advantageously possible to implement at least two measuring principles in a single apparatus. The sensor unit, on the one hand, executes mechanical oscillations; additionally, a transmitted signal is transmitted. In reaction to the mechanical oscillations and the transmitted signal, two received signals are received and evaluated as regards at least two different process variables. The two received signals can, in such case, advantageously be evaluated independently of one another. Thus, the number of ascertainable process variables can be significantly increased, resulting in a greater functionality and/or expanded range of applications for a sensor.

In an embodiment of the method, the excitation signal is an electrical signal having at least one predeterminable excitation frequency, especially a sinusoidal, rectangular, trapezoidal, triangular or sawtooth-shaped signal.

In an additional embodiment, the transmitted signal is an electrical signal having at least one predeterminable transmission frequency, especially a rectangular, trapezoidal, triangular or sawtooth-shaped signal, preferably a sinusoidal signal.

In a preferred embodiment, a value for transmission frequency of the transmitted signal is selected as a function of distance between the first component of the sensor unit and the second component of the sensor unit or a wall of the containment. In this regard, advantageously, the value for the transmission frequency is selected in such a manner that the distance is a whole numbered multiple of the half wavelength.

By correspondingly choosing the transmission frequency, it can be assured that a standing wave arises between a first component of the sensor unit and a second component of the sensor unit or a wall of the containment.

In an additional embodiment of the method, the value for the transmission frequency is ascertained based on an impedance or a phase between the transmitted signal and the second received signal as a function of transmission frequency. Especially, a so-called frequency sweep can be performed, in which case the transmitted signal passes successively through different transmission frequencies of a predeterminable frequency interval. Using the frequency sweep, then, in turn, a resonance in the medium can be ascertained.

In this regard, advantageously, information concerning a deposit or a bubble formation in the region of the sensor unit, or concerning a damping of the sensor unit, is gained based on the impedance or the phase between the transmitted signal and the second received signal as a function of transmission frequency. The invention, thus, enables supplementally, the performing of a state monitoring of the sensor unit. For example, for state monitoring, width of a resonance peak of the received signal can be evaluated as a function of transmission frequency.

In an embodiment of the method of the invention, first and second values for the transmission frequency of the transmitted signal as a function of distance between the first component of the sensor unit and the second component of the sensor unit or the wall of the containment are selected and taken into consideration for determining the second process variable. Both the first as well as also the second transmission frequency are, in such case, preferably selected in such a manner that a standing wave in the medium between the first component of the sensor unit and the second component of the sensor unit or the wall of the containment is produced. By application of transmitted signals with two different transmission frequencies, different influencing variables can be eliminated for determining and/or monitoring the process variable, for example, an influence of temperature or a concentration change of at least one component of the medium. In this way, the accuracy of measurement of a corresponding measuring device suitable for performing the method of the invention can be further increased.

In an additional embodiment, the first process variable is the density of the medium and the second process variable is the velocity of sound within the medium or a variable derived therefrom.

Additionally, preferably, at least a third process variable, especially viscosity of the medium, can be determined.

A preferred embodiment of the method of the invention includes that the sensor unit comprises a mechanically oscillatable unit in the form of an oscillatory fork with two oscillatory elements and at least one piezoelectric element, wherein the piezoelectric element is arranged, at least partially, within an oscillatory element. Corresponding embodiments of a sensor unit are described, for example, in DE102012100728A1 and DE102017130527A1. Comprehensive reference is taken to these two applications in the context of the present invention. In the case of the possible embodiments of the sensor unit described in these two documents, they are examples of possible structural embodiments of the sensor unit. It is, for example, not absolutely necessary to arrange the piezoelectric elements exclusively in the region of the oscillatory elements. Rather, individuals of the applied piezoelectric elements can be arranged also in the region of a diaphragm or in additional oscillatory elements not used for the vibronic excitation and likewise mounted on a diaphragm.

Then, advantageously, the standing wave is produced between the two oscillatory elements, especially a transmission frequency of the transmitted signal is selected as a function of a distance between the two oscillatory elements.

In the case, in which the sensor unit comprises a single piezoelectric element, the other oscillatory element serves, for example, for reflection of the transmitted signal, which is then received by the piezoelectric element as the second received signal. In an additional embodiment, the sensor unit can, however, also comprise first and second piezoelectric elements, wherein the first piezoelectric element is arranged, at least partially, within the first oscillatory element and a second piezoelectric element, at least partially, within the second oscillatory element.

Then, the first piezoelectric element can serve for transmitting the transmitted signal, while the second piezoelectric element serves for receiving the second received signal.

It is, however, likewise advantageous that a first transmitted signal is transmitted by means of the first piezoelectric element and a second transmitted signal is transmitted by means of the second piezoelectric element, wherein the first and second transmitted signals are selected in such a manner that the two transmitted signals are of equal phase. In such case, a superpositioning of the first and second transmitted signal, and the corresponding, received signals, results. This has the advantage that standing waves having wavelengths, which are odd multiples of the half wavelength, are not excited.

The invention and advantageous embodiments thereof will now be explained in greater detail based on the appended drawing, the figures of which show as follows:

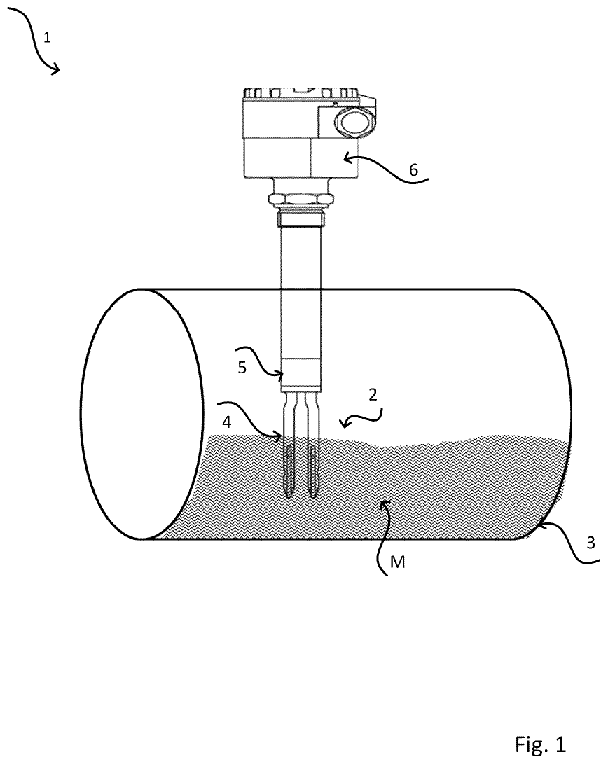

FIG. 1 a schematic view of a vibronic sensor according to the state of the art,

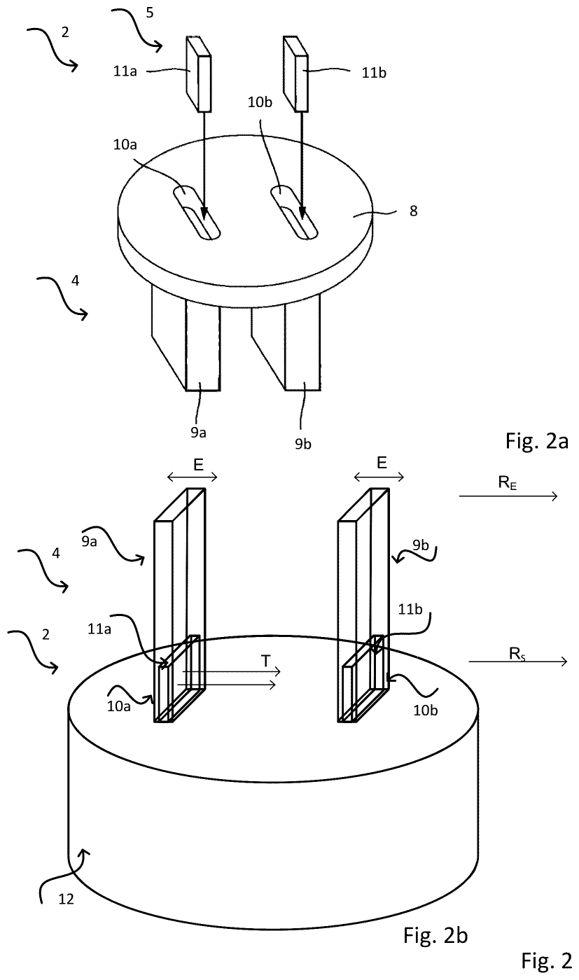

FIG. 2 different possible embodiments for vibronic sensors according to the state of the art, in the case of which piezoelectric elements are arranged within the oscillatory elements,

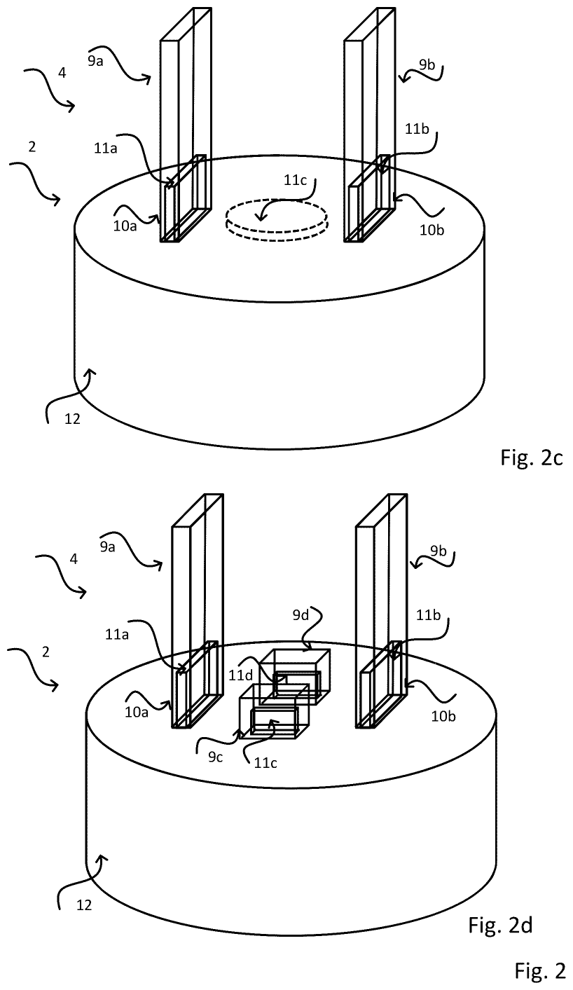

FIG. 3 a first preferred embodiment of the method of the invention,

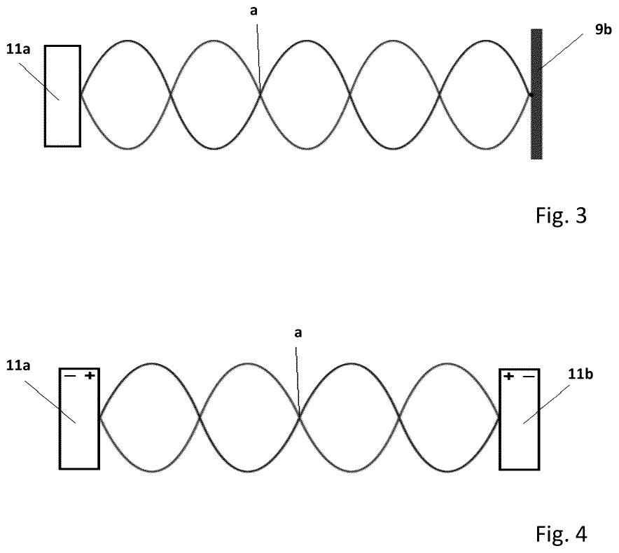

FIG. 4 a second preferred embodiment of the method of the invention,

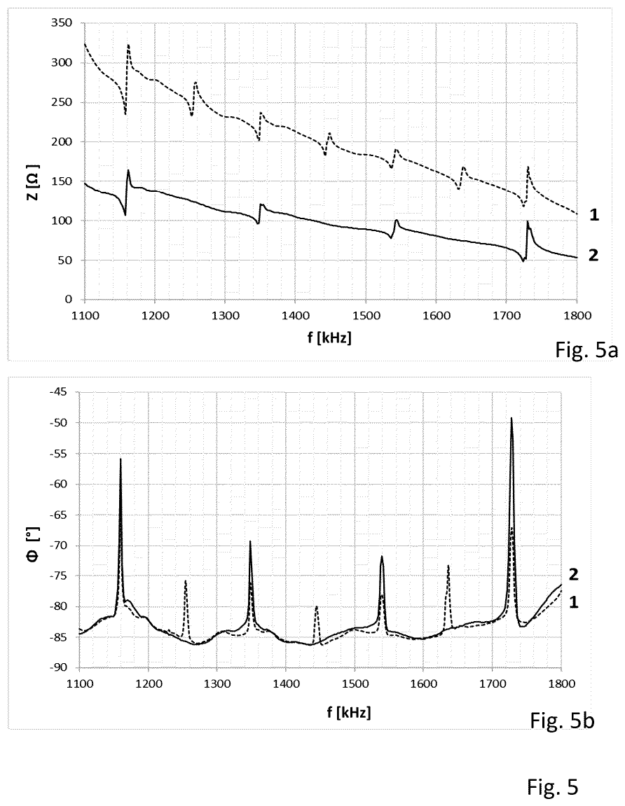

FIG. 5 by way of example, different resonance spectra corresponding to the first and second examples of embodiments of FIGS. 3 and 4, and

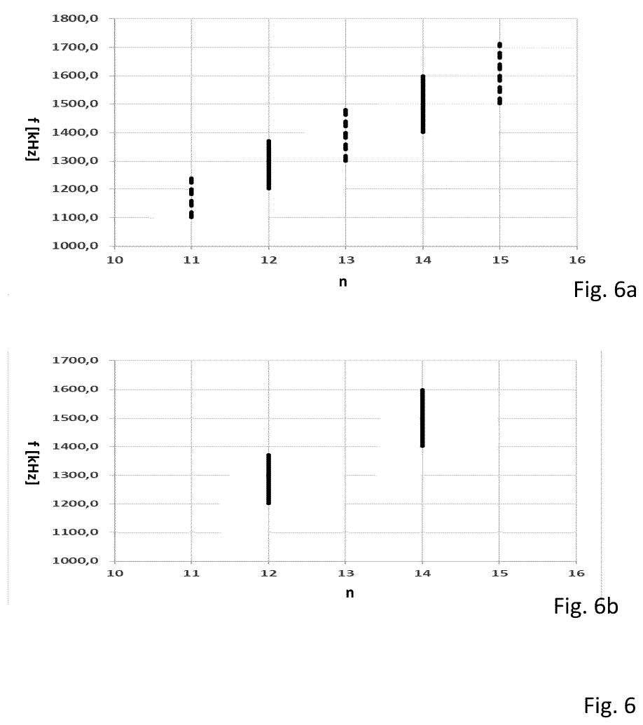

FIG. 6 different overlapping of value ranges for the transmission frequency of the transmitted signal in the case of different resonances for the examples of embodiments of FIGS. 3 and 4.

In the figures, equal elements are provided with equal reference characters.

FIG. 1 shows a vibronic sensor 1 with a sensor unit 2. The sensor includes a mechanically oscillatable unit 4 in the form of an oscillatory fork, which is partially immersed in a medium M located in a container 3. Oscillatable unit 4 is excited by means of the exciting/receiving unit 5, such that the oscillatable unit executes mechanical oscillations. For example, a piezoelectric stack- or bimorph drive can be used. Other vibronic sensors operate, for example, via electromagnetic exciting/receiving units 5. It is possible to use a single exciting/receiving unit 5, which serves for exciting the mechanical oscillations as well as for their detection. Likewise, however, it is also known to implement separate driving and receiving units. FIG. 1 includes, furthermore, an electronics 6, by means of which signal registration, —evaluation and/or—feeding occurs.

FIG. 2 shows, by way of example, an assortment of sensor units 2 of vibronic sensors 1, in the case of which the piezoelectric elements 5 are arranged in an internal volume of the oscillatable unit. The mechanically oscillatable unit 4 shown in FIG. 2a comprises, mounted on a base 8, two oscillatory elements 9a,9b, which are also referred to as the tines of a fork. Optionally, paddles (not shown) can be formed on the ends of the two oscillatory elements 9a,9b. Introduced into each of the two oscillatory elements 9a, 9b are, especially pocket-like, hollow spaces 10a, 10b, in which, in each case, at least one piezoelectric element 11a, 11b of the exciting/receiving unit 5 is arranged. Preferably, the piezoelectric elements 11a and 11b are potted within the hollow spaces 10a and 10b. The hollow spaces 10a, 10b can, in such case, be so formed that the two piezoelectric elements 11a, 11b are located completely or partially in the region of the two oscillatory elements 9a, 9b. Such an arrangement as well as other similar arrangements are described at length in DE102012100728A1.

Another example of a possible embodiment of a sensor unit 2 is shown in FIG. 2b. The mechanically oscillatable unit 4 has two mutually parallel, here bar-shaped, oscillatory elements 9a, 9b mounted on a disc shaped element 12. The oscillatory elements 9a, 9b are excitable to execute mechanical oscillations separately from one another and their oscillations can likewise be received and evaluated separately from one another. Each of the oscillatory elements 9a and 9b has a hollow space 10a and 10b, in which is arranged in the region facing the disc shaped element 12, in each case, at least one piezoelectric element 11a and 11b. Regarding the embodiment of FIG. 2b, reference is made to DE102017130527A1.

As shown schematically in FIG. 2b, the sensor unit 2 is, on the one hand, supplied with an excitation signal E, in such a manner that the oscillatable unit 4 is excited to execute mechanical oscillations. The oscillations are produced, in such case, by means of the two piezoelectric elements 11a and 11b. The two piezoelectric elements can be supplied with the same excitation signal E, but also a supplying of the first oscillatory element 11a with a first excitation signal E₁ and the second oscillatory element 11b with a second excitation signal E₂ is possible. Likewise, a first received signal R_{E} can be received based on the mechanical oscillations, or separate received signals R_{E1}, R_{E2} can be received, one from oscillatory element 9a and one from oscillatory element 9b.

Moreover, additionally, for example, emanating from the first piezoelectric element 11a, a transmitted signal T can be transmitted, which is received by the second piezoelectric element 11b in the form of a second received signal R_{T}. Since the two piezoelectric elements 11a and 11b are arranged at least in the region of the oscillatory elements 9a and 9b, the transmitted signal T passes through the medium M and is correspondingly influenced by the properties of the medium M, when the sensor unit 2 is in contact with the medium M. Likewise, it is, however, an option that the transmitted signal T is transmitted from the first piezoelectric element 11a in the region of the first oscillatory element 9a and is reflected on the second oscillatory element 9b. In such case, the second received signal R_{T} is received by the first piezoelectric element 11a. The transmitted signal T passes, in such case, two times through the medium M.

Besides these two illustrated embodiments of an apparatus 1 of the invention, numerous other variants are possible, which likewise fall within the scope of the invention. For example, it is possible for the embodiments of FIGS. 2a and 2b to use only one piezoelectric element 11a, 11b, which is arranged in at least one of the two oscillatory elements 9a, 9b. In such case, piezoelectric element 11a serves for producing the excitation signal, and the transmitted signal T, as well as for receiving the first received signal R_{E} and the second received signal R_{T}. Then, the transmitted signal T is transmitted from the first piezoelectric element 11a in the region of the first oscillatory element 9a and reflected on the second oscillatory element 9b, so that also the second received signal R_{T} is received by the first piezoelectric element 11a. The transmitted signal T passes, in such case, through the medium M two times, this resulting in a doubling of a travel time T of the transmitted signal T.

Another possibility is shown, by way of example, in FIG. 2c. In this case, a third piezoelectric element 11c is provided in the region of the diaphragm 12. The third piezoelectric element 11c serves for producing the excitation signal E and for receiving the first received signal R_{E}; the first piezoelectric element 11a and second piezoelectric element 11b serve for producing the transmitted signal T, and for receiving the second received signal R_{T}. Alternatively, it is, for example, possible to produce the excitation signal E and the transmitted signal T as well as to receive the second received signal R_{T} all with the first piezoelectric element 11a and/or second piezoelectric element 11b, wherein the third piezoelectric element 11c serves for receiving the first received signal R_{E}. Likewise it is possible to produce the transmitted signal T with the first 11a and/or second piezoelectric element 11b and the excitation signal E with the third piezoelectric element 11c and to receive the first received signal R_{E} and/or second received signal R_{T} with the first 11a and/or second piezoelectric element 11b. Also in the case of FIG. 2c, it is for other embodiments possible to omit the first piezoelectric element 11a or the second piezoelectric element 11b.

Another possible embodiment of the apparatus 1 is shown in FIG. 2d. The apparatus includes, starting from the embodiment of FIG. 2b, a third oscillatory element 9c and a fourth oscillatory element 9d. These do not, however, serve for oscillation production. Rather, a third piezoelectric element 11c and fourth piezoelectric element 11d are arranged respectively in the additional elements 9c, 9d. In such case, the vibronic measuring is performed by means of the first two piezoelectric elements 11a, 11b and the ultrasonic measuring by means of the other two piezoelectric elements 11c, 11d. Also in such case, for each measuring principle, one piezoelectric element, e.g. 11b and 11d, can be omitted. For reasons of symmetry, it is, however, advantageous, always to use two additional oscillatory elements 9c, 9d.

According to the invention, the transmitted signal T is selected in such a manner that a standing wave is produced at least in a part of the medium M between a first component of the sensor unit 2, for example, the first piezoelectric element 11a, and a second component of the sensor unit 2, especially the second oscillatory element 9b or an additional piezoelectric element 11b, or a wall of the container 3, thus, a superpositioning of two oppositely moving waves of equal transmission frequency and equal amplitude, in the case of which deflection is always zero at oscillation nodes a. In order to determine a transmission frequency f_{T} for the transmitted signal T, for example, a frequency sweep in a predeterminable frequency interval can be performed and an impedance Z or phase ¢ between an input and output measured within the electronics 6.

FIG. 3 shows a first embodiment of the method of the invention. In such case, the apparatus 1 applied for performing the method comprises a single piezoelectric element, e.g. 11a, which is used for producing and transmitting the transmitted signal T. The transmitted signal T is reflected on the second oscillatory element 9b and received by the first piezoelectric element 11a. Standing waves form between the first piezoelectric element 11a (not shown) in the first oscillatory element 9a and the second oscillatory element 9b, when the distance between two neighboring nodes amounts to half the wavelength A of the original wave.

The apparatus 1, which is used for performing a method of the invention, can, however, also comprise two piezoelectric elements 11a and 11b, which can be arranged, for example, in oscillatory elements 9a and 9b, respectively. In such case, the second piezoelectric element 9b can serve, for example, for receiving the second received signal R_{T}. It is, however, also possible that a first transmitted signal T₁ and a second transmitted signal T₂ are transmitted by means of the two piezoelectric elements 9a and 9b, respectively, wherein the two transmitted signals T₁ and T₂ are of equal phase. This offers further metrological advantages, such as will be explained below based on FIGS. 5 and 6.

Shown in FIG. 5 are typical resonance spectra of impedance Z (FIG. 5a) and phase Φ (FIG. 5b) as a function of transmission frequency f_{T} in the case of water and corresponding to the embodiments described with reference to FIG. 3 (curves 1) and FIG. 4 (curves 2). While for the curves 1 corresponding to the embodiment of FIG. 3, thus, in the case of use of a single transmitted signal T, all resonances nλ/2 show up, in the case of the embodiment of FIG. 4 (curves 2), resonances for n an odd number are, in contrast, not excited. This has the advantage that overlappings of value ranges for neighboring resonance frequencies due to various transmission frequency influencing variables, for example, temperature or changes of the concentration of at least one component of the medium, can be prevented. This is also illustrated in FIG. 6.

FIG. 6a shows the value ranges for the transmission frequencies at resonances with n=11-15 for an aqueous solution for temperatures T of the medium in the range T=0-99° C. Significantly, value ranges of the temperature dependent transmission frequency f_{T} overlap for neighboring resonances n and n+1. In contrast, when two piezoelectric elements 11a and 11b are used and equal phase transmitted signals T are transmitted by means of the two piezoelectric elements 11a and 11b, resonances, for which n is an odd number, are not excited; compare FIG. 6b. Then, value ranges of transmission frequency f_{T} for neighboring resonances no longer overlap or overlap significantly less, this in turn enabling a simplified evaluation of the second received signal R_{T}.

In summary, application of a method of the invention enables improved measuring performance of vibronic multisensors 1, which work according to the vibronic measuring principle and according to the ultrasonic measuring principle independently of one another, such that a plurality of process variables of a medium M can be determined. The accuracy of measurement as regards the ultrasonic measuring principle is in the case of other evaluation types greatly influenced by the distance the transmitted signal T travels, a feature which significantly hampers the implementing of compact, small sensors 1. This problem can be avoided using an indirect evaluation of the second received signal R_{T} involving the forming of a standing wave. By evaluating the second received signal R_{T} at different resonance frequencies f_{T}, additionally, various influencing factors affecting the process variable determination can be compensated, or eliminated and/or a state monitoring of the sensor unit 4 performed.

### LIST OF REFERENCE CHARACTERS

1 vibronic sensor
2 sensor unit
3 container
4 oscillatable unit
5 exciting/receiving unit
6 electronics
8 base
9a, 9b oscillatory elements
10a, 10b hollow spaces
11a, 11b piezoelectric elements
M medium
P process variable
T temperature
E excitation signal
T transmitted signal
R_{E} first received signal
R_{T} second received signal
Z impedance
Φ phase
f_{T} transmission frequency of the transmitted signal
λ wavelength of the transmitted signal
n natural number
a oscillation node

1-14. (canceled)

15. A method for determining and/or monitoring a first process variable and a second process variable of a medium in a containment, the method comprising:
exciting a sensor unit using an excitation signal such that mechanical oscillations are executed;
receiving the mechanical oscillations by the sensor unit and converting the mechanical oscillations into a first received signal;
transmitting a transmitted signal from the sensor unit and receiving a second received signal; and
calculating a first process variable based on the first received signal and calculating a second process variable based on the second received signal
wherein the transmitted signal is selected such that a standing wave is produced at least in a part of the medium between a first component of the sensor unit and a second component of the sensor unit or a wall of the containment.

16. The method as claimed in claim 15,
wherein the excitation signal is an electrical signal having at least one predeterminable excitation frequency and a sinusoidal, rectangular, trapezoidal, triangular, or sawtooth shape.

17. The method as claimed in claim 15,
wherein the transmitted signal is an electrical signal having at least one predeterminable transmission frequency and a rectangular, trapezoidal, triangular, or sawtooth shape.

18. The method as claimed in claim 15,
wherein a transmission frequency of the transmitted signal is selected as a function of a distance between the first component of the sensor unit and the second component of the sensor unit or the wall of the containment.

19. The method as claimed in claim 18,
wherein the transmission frequency is selected such that the distance is a whole numbered multiple of a half wavelength of the transmitted signal.

20. The method as claimed in claim 19,
wherein the transmission frequency is ascertained based on an impedance or a phase between the transmitted signal and the second received signal as a function of transmission frequency.

21. The method as claimed in claim 20,
wherein information concerning a deposit or a bubble formation in a region of the sensor unit or concerning damping of the sensor unit is gained based on the impedance or the phase between the transmitted signal and the second received signal as a function of transmission frequency.

22. The method as claimed in claim 15, further comprising:
selecting a first transmission frequency and a second transmission frequency of the transmitted signal as a function of a distance between the first component of the sensor unit and the second component of the sensor unit or the wall of the containment,
wherein the first transmission frequency and the second transmission frequency are taken into consideration for calculating the second process variable.

23. The method as claimed in claim 15,
wherein the first process variable is a density of the medium and the second process variable is a velocity of sound within the medium or a variable derived therefrom.

24. The method as claimed in claim 15, further comprising:
determining at least a third process variable.

25. The method as claimed in claim 15,
wherein the sensor unit comprises a mechanically oscillatable unit in the form of an oscillatory fork having two oscillatory elements and at least one piezoelectric element, and
wherein the at least one piezoelectric element is arranged, at least partially, within an oscillatory element.

26. The method as claimed in claim 25,
wherein the standing wave is produced between the two oscillatory elements, and a transmission frequency of the transmitted signal is selected as a function of a distance between the two oscillatory elements.

27. The method as claimed in claim 26,
wherein the at least one piezoelectric element includes a first piezoelectric element and a second piezoelectric element, and wherein the first piezoelectric element is arranged, at least partially, within the first oscillatory element and a second piezoelectric element is arranged, at least partially, within the second oscillatory element.

28. The method as claimed in claim 27,
wherein a first transmitted signal is transmitted by the first piezoelectric element, wherein a second transmitted signal is transmitted by the second piezoelectric element, and wherein the first transmitted signal and the second transmitted signal are of equal phase.
